(19) United States
(12) Patent Application Publication
(10) Pub. No.: US 2024/0208831 A1
(43) Pub. Date: Jun. 27, 2024

(54) METHOD OF PREPARING ANHYDROUS LITHIUM IODIDE

(71) Applicant: TAIAN HAVAY CHEMICALS CO., LTD., Tai'an City (CN)

(72) Inventors: Guibin SUN, Tai'an City (CN); Hecun LI, Tai'an City (CN); Shuzhen REN, Tai'an City (CN); Weihu REN, Tai'an City (CN)

(21) Appl. No.: 18/085,804

(22) Filed: Dec. 21, 2022

(51) Int. Cl. C01D 15/04; B01D 3/14; B01D 3/36

(52) U.S. Cl. CPC C01D 15/04; B01D 3/145; B01D 3/36

(57) ABSTRACT

The invention relates to the field of new battery materials, in particular, to a method for preparing anhydrous lithium iodide. The method includes: preparing a crude lithium iodide product by reacting industrial grade lithium hydroxide monohydrate with hydroiodic acid; dissolving the crude lithium iodide in solvent/ethanol and removing impurities by membrane filtration to obtain a refined lithium iodide ethanol/water solution; processing the solution by drying and recycling ethanol under the protection of inert or reducing gas; separating the solid under inert or reducing gas and vacuum drying to obtain high-purity anhydrous lithium iodide. The lithium hydroxide or lithium carbonate used in the present invention is of ordinary industrial grade. Because the solvent/ethanol is recycled after drying, the amount of the solvent used is greatly reduced. The problem that the moisture inside the product cannot be removed after being directly evaporated to dryness is avoided.

### TECHNICAL FIELD

The invention relates to the field of battery materials, in particular, to a method of preparing anhydrous lithium iodide.

### BACKGROUND TECHNIQUE

Lithium primary batteries with organic electrolytes have the advantages of high capacity and high power density, and have become one of the fastest growing types of lithium primary batteries in recent years. The organic electrolyte of anhydrous lithium iodide has excellent performance in lithium-iron batteries, which has become a research hotspot in recent years. Anhydrous lithium iodide is easy to be oxidized and has strong water absorption. The lithium iodide used in the battery industry has extremely high moisture and content requirements, and is difficult and expensive to prepare. The main methods for preparing anhydrous lithium iodide in current research reports are: pyrometallurgy, organic solvent method and wet synthesis. The first two methods have harsh reaction conditions and are difficult to achieve industrialization.

Chinese patent application number CN 201910501973.6 discloses an industrialized preparation method of battery-grade lithium iodide. In this method, lithium iodide hydrate is placed in a stirring and dispersing machine under vacuum, and the lithium iodide hydrate is dehydrated to a viscous substrate under negative pressure and high temperature. The viscous substrate is then stirred at high speed to prevent agglomeration and to disperse into a dry powder. The disadvantage is: on the one hand, the dehydration process of this method has no solvent or gas protection, and if air enters the disperser under high temperature, the product is easily oxidized and deteriorated. The tightness and operation requirements of the dispersing process are high. On the other hand, the method adopts a direct evaporation process to dryness. There is no impurity removal process. The requirements on raw material quality and the cost are high.

Chinese patent application number CN 201410477477.9 discloses a preparation method of battery-grade lithium iodide. The method uses a reaction of lithium carbonate or lithium hydroxide with hydroiodic acid.

An impurity remover is added, and the reaction mixture is concentrated to obtain lithium iodide hydrate. Lithium iodide hydrate is mixed with an organic solvent, and evaporated to dryness under negative pressure to obtain a lithium iodide solid, which is pulverized to obtain a product. The disadvantage is: on the one hand, the introduction of the impurity remover can only be a directional impurity removal, not a comprehensive impurity removal, and the impurity removal process is not thorough. On the other hand, the final product is evaporated to dryness. Although the product can be obtained, but the product is seriously agglomerated, and it is difficult to remove the moisture and solvent wrapped in the agglomeration. And the product needs to be pulverized after being discharged, and it is easy to be polluted during the pulverization process. The pulverization process needs a clean, anhydrous and oxygen-free environment, and the conditions are stringent.

Therefore, there is a need for a method for preparing higher purity anhydrous lithium iodide for those skilled in the art.

### SUMMARY OF THE INVENTION

Aiming at the problems existing in the prior art, the present invention provides a method for preparing anhydrous lithium iodide. Specifically, industrial grade lithium hydroxide monohydrate or lithium carbonate reacts with hydroiodic acid to prepare crude lithium iodide hydrate. High-purity anhydrous lithium iodide is prepared through two steps of impurity removal and dehydration of the crude lithium iodide hydrate. Industrial grade and inexpensive lithium hydroxide monohydrate or lithium carbonate is used as starting material to prepare lithium iodide hydrate. Crude lithium iodide hydride is dissolved in an organic solvent, and membrane filtration is used to remove impurities to obtain a purified lithium iodide solution. Industrial grade lithium hydroxide monohydrate or lithium carbonate is the main source of lithium, and its cost is relatively low. Dehydration under a negative pressure and the protection of inert gas or reducing gas can avoid the decomposition of lithium iodide caused by high temperature dehydration, and the solvent is dried and reused, avoiding the use of a large amount of solvent and the product agglomeration after the solvent evaporates and absorbs the internal moisture. To solve the problem that internal moisture cannot be removed, the method of the present invention has high safety and simple operation, and the content of the obtained product meets the requirements of high-purity product with respect to the content of impurity ions and water.

The specific technical solutions of this application are as follows:

In one embodiment, a method of preparing an anhydrous lithium iodide include: a lithium iodide trihydrate preparation step, a lithium iodide trihydrate dissolving step, a membrane filtration step, an azeotropic distillation step, a solvent recovery step, a solid-liquid separation step, and a solvent removal step. The lithium iodide trihydrate preparation step includes reacting an industrial grade lithium hydroxide monohydrate with a hydroiodic acid under a condition of not exceeding 80° C., maintaining a negative pressure of 0.075-0.09 Mpa, and heating to 90° C.-110° C. to remove water, cooling and crystallizing to obtain a lithium iodide trihydrate; the lithium iodide trihydrate dissolving step includes dissolving the lithium iodide trihydrate in absolute ethanol in a 1:1-5 mass ratio under stirring to obtain a lithium iodide ethanol solution; the membrane filtration step includes adjusting a pH of the lithium iodide ethanol solution with a battery-grade lithium hydroxide, removing impurity through a membrane filtration device equipped with a membrane element under a pressure of 0.1-3.0 Mpa, and adjusting the pH of the lithium iodide ethanol solution again with a hydriodic acid; the azeotropic distillation step includes keeping the lithium iodide ethanol solution under the protection of a dry inert gas or reducing gas and a negative pressure of 0.08-0.09 Mpa, heating to 145-160° C. to continuously distill ethanol and water, passing the distilled ethanol and water through a drying tube to absorb the distilled water, returning the distilled ethanol to the lithium iodide ethanol solution, until a water content in the lithium iodide ethanol solution is reduced to 0.01-0.1%; the solvent recovery step includes evaporating the ethanol in the lithium iodide ethanol solution for precipitation to obtain a solid-liquid mixture, recovering the ethanol for reuse, closing a vacuum valve, and introducing a nitrogen protection; the solid-liquid separation step includes introducing the solid-liquid mixture into a nitrogen pressure filter device under the nitrogen protection to obtain a solid; and the solvent removal step includes transferring the solid to a negative pressure oven to maintain a negative pressure of 0.085-0.1 MPa, and drying at 135-150° C. to obtain the anhydrous lithium iodide.

In another embodiment, in the lithium iodide dissolving step, the mass ratio of the lithium iodide trihydrate to the absolute ethanol in a 1:2.5.

In another embodiment, in the membrane filtration step, before membrane filtration, the pH of the lithium iodide ethanol solution is adjusted to 7-13 with the battery-grade lithium hydroxide; the pressure of the membrane filtration device is 0.1-3.0 Mpa; the membrane filtration device is a nanofiltration device; a pore size of the membrane element is 100 D-500 D; after membrane filtration, the pH is adjusted with a redistilled colorless hydriodic acid to 6.0-8.0.

In another embodiment, before membrane filtration, the pH of the lithium iodide ethanol solution is adjusted to 10 with the battery-grade lithium hydroxide; the pressure of the membrane filtration device is 0.4-1.0 Mpa; the pore size of the membrane element is 150 D-250 D; after membrane filtration, the pH is adjusted with a redistilled colorless hydriodic acid to 7.0.

In another embodiment, in the azeotropic distillation step, the dry inert gas is argon or nitrogen, and the reducing gas is hydrogen; the lithium iodide ethanol solution is heated at 150° C.; the drying tube comprises calcium oxide or molecular sieve; and the water content in the lithium iodide ethanol solution is reduced to 0.02%.

In another embodiment, drying tube includes molecular sieve.

In another embodiment, in the solvent removal step, the negative pressure is maintained at more than 0.09 MPa in the negative pressure oven and drying is at 140° C.

Compared with the prior art, the main features of the present invention are:

The starting material is ordinary industrial grade lithium hydroxide monohydrate or lithium carbonate, which is inexpensive and easy to obtain. The impurity removal in the impurity removal step is based on the electrostatic interaction between the nanofiltration membrane and the electrolyte ions, and the charge strength of the electrolyte salt ions is different, resulting in the interception of ions by the membrane. In a multi-component system containing different valence ions, divalent ions are easier to be preferentially removed. At the same time, different pore sizes of the membrane represent different retention rates for different atomic mass fractions. The lithium ion concentration is the highest, and the relative atomic mass is the smallest, so the retention rate is different. The retention rate of lithium ion is the smallest, and other ions are more easily trapped. Battery-grade lithium hydroxide monohydrate is used to adjust the pH of the lithium iodide solution to 10. The solubility of calcium, magnesium, zinc, nickel, lead and other ions in alkaline solution is relatively low, so they are removed.

The negative pressure in the dehydration stage is protected by a small amount of nitrogen, which not only ensures that there is always nitrogen protection in the entire dehydration reactor, but also ensures that the lithium iodide is not easily oxidized for a long time during the dehydration process. It can also bring out a large amount of solvent and water. The present invention adopts ethanol dehydration and recycling, which not only ensures that a large amount of ethanol participates in carrying water, but also ensures that the ethanol is not wasted, thereby greatly reducing the moisture in the entire reaction system and crystallizing the anhydrous lithium iodide in the solvent, keeping the residual sodium, potassium, rubidium and chlorine in the mother liquor. Compared with other processes, the inventive method has the advantages of no solid agglomeration and less impurity content.

In summary, the method of the present invention has the advantages of low cost, high safety and simple operation, and the content of the obtained product meets the requirements of high-purity product with respect to the content of impurities and water.

### DESCRIPTION OF DRAWINGS

FIG. 1 is a process flow diagram of the method of the present invention.

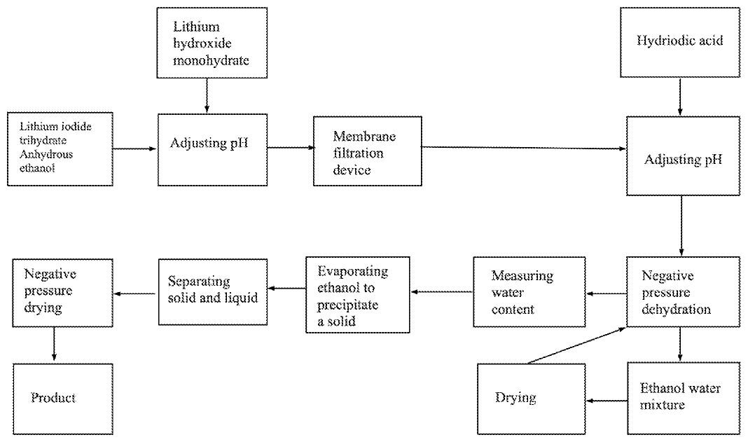

### DETAILED DESCRIPTION

The present invention is further described below in conjunction with the examples, which can make those skilled in the art understand the present invention more comprehensively, but do not limit the present invention in any way.

### Example 1

A method of preparing high-purity anhydrous lithium iodide included the following steps:

300 g of industrial grade lithium hydroxide monohydrate was dissolved in 300 g of pure water, stirred until the solution is uniform. 1604 g of 57% hydriodic acid was added in batches under stirring. After the reaction was completed, the reaction solution was adjusted to pH=7.0. After 30 minutes, the pH value was remeasured to be 7.0-7.5. 1.5 g activated carbon was added to the solution, heated up to 80° C., decolorized and filtered to obtain a transparent lithium iodide solution.

The obtained lithium iodide solution was concentrated under a negative pressure of 0.09 Mpa, gradually warmed up to 95° C. and concentrated until there was no more water to steam out, and cooled. The solid in the solution was separated to obtain 960 g of lithium iodide hydrate as an acicular solid.

140 g of acicular lithium iodide hydrate solid was placed in 400 g of absolute ethanol, and stirred until the solid was completely dissolved to obtain a lithium iodide ethanol solution.

The lithium iodide ethanol solution was injected into a dehydration reactor, and 1000 g of 3 A molecular sieves were added in a drying tube, and a valve was opened to feed nitrogen, and the nitrogen was replaced three times. Nitrogen was introduced into the valve to control the negative pressure of 0.85 Mpa, and the temperature was set to 150° C. Ethanol and water mixture was continuously evaporated and dried through the drying tube, and dried ethanol was then continuously replenished to the dehydration reactor.

After heating for 5 hours, a sample was taken under nitrogen protection, and Karl Fischer was used to measure the moisture. After the moisture content was measured to be less than 0.02%, the ethanol dripping valve was closed, the valve of the receiving tank was opened, and the solvent was evaporated until a large amount of solid was precipitated. After cooling under nitrogen protection, the mixture was transferred to a nitrogen pressure filtration device to separate the solid-liquid mixture to obtain solid. The solid was transferred to a negative pressure oven, heated at 140° C., for 3 h, to obtain 76 g of anhydrous lithium iodide solid.

### Example 2

A method of preparing high-purity anhydrous lithium iodide included the following steps:

140 g of the acicular lithium iodide hydrate solid prepared in Example 1 was placed in 400 g of absolute ethanol, and stirred until the solid is completely dissolved to obtain a lithium iodide ethanol solution.

The lithium iodide ethanol solution was passed into a nanofiltration membrane with a pore size of 200 Daltons, the operating pressure was 0.41 MPa. The solvent ethanol and the product lithium iodide passed through the filter membrane to obtain 405 g of purified lithium iodide solution, and impurities were removed. The impurities were retained by the membrane and discharged.

The purified lithium iodide solution obtained in the previous step was poured into a dehydration reactor. 1000 g of 3 A molecular sieve was added to the drying tube, the valve was opened to feed nitrogen, the nitrogen was replaced three times, the opening of the nitrogen feed valve was opened to 5%, and the negative pressure pump was opened. The negative pressure was controlled by a nitrogen valve to 0.09 Mpa, and the temperature was set to 155° C. After the continuously evaporated ethanol with water was dried by a drying tube, dried ethanol was continuously replenished to the dehydration reactor.

After heating for 6 hours, a sample was under nitrogen protection, and Karl Fischer was used to measure the moisture. After the moisture content was measured to be less than 0.02%, the ethanol dripping valve was closed, the valve of the receiving tank was opened, and the solvent was evaporated until a large amount of solid was precipitated. After cooling under nitrogen protection, the mixture was transferred to a nitrogen pressure filter device to separate the solid-liquid mixture to obtain solid. The solid was transferred to a negative pressure oven, heated at 140° C., for 3 h, to obtain 60 g of anhydrous lithium iodide solid.

### Example 3

A method of preparing high-purity anhydrous lithium iodide included the following steps:

140 g of the acicular lithium iodide hydrate solid prepared in Example 1 was placed in 400 g of absolute ethanol, and stirred until the solid is completely dissolved to obtain a lithium iodide ethanol solution.

To the lithium iodide ethanol solution obtained above, electronic grade lithium hydroxide was added to adjust pH=10. The solution was then passed through a nanofiltration membrane with a pore size of 100 Daltons, under a pressure of 0.5 MPa. The solvent ethanol and the product lithium iodide passed through the filter membrane to obtain 256 g of purified lithium iodide solution. The pH of the solution was adjusted again to 7.0-7.5 with re-distilled hydriodic acid. The impurities were retained by the membrane and discharged.

The purified lithium iodide solution obtained in the previous step was poured into a dehydration reactor. 1000 g of 3 A molecular sieve was added to the drying tube, the valve was opened to feed nitrogen, the nitrogen was replaced three times, the opening of the nitrogen feed valve was opened to 5%, and the negative pressure pump was opened. The negative pressure was controlled by a nitrogen valve to 0.088 Mpa, and the temperature was set to 160° C. After the continuously evaporated ethanol with water was dried by a drying tube, dried ethanol was continuously replenished to the dehydration reactor.

After heating for 4 hours, a sample was under nitrogen protection, and Karl Fischer was used to measure the moisture. After the moisture content was measured to be less than 0.02%, the ethanol dripping valve was closed, the valve of the receiving tank was opened, and the solvent was evaporated until a large amount of solid was precipitated. After cooling under nitrogen protection, the mixture was transferred to a nitrogen pressure filter device to separate the solid-liquid mixture to obtain solid. The solid was transferred to a negative pressure oven, heated at 140° C., for 3 h, to obtain 38.3 g of anhydrous lithium iodide solid.

### Example 4

A method of preparing high-purity anhydrous lithium iodide included the following steps:

140 g of the acicular lithium iodide hydrate solid prepared in Example 1 was placed in 400 g of absolute ethanol, and stirred until the solid is completely dissolved to obtain a lithium iodide ethanol solution.

To the lithium iodide ethanol solution obtained above, electronic grade lithium hydroxide was added to adjust pH=10. The solution was then passed through a nanofiltration membrane with a pore size of 200 Daltons, under a pressure of 0.4 MPa. The solvent ethanol and the product lithium iodide passed through the filter membrane to obtain 420 g of purified lithium iodide solution. The pH of the solution was adjusted again to 7.0-7.5 with re-distilled hydriodic acid. The impurities were retained by the membrane and discharged.

The purified lithium iodide solution obtained in the previous step was poured into a dehydration reactor. 1000 g of 3 A molecular sieve was added to the drying tube, the valve was opened to feed nitrogen, the nitrogen was replaced three times, the opening of the nitrogen feed valve was opened to 5%, and the negative pressure pump was opened. The negative pressure was controlled by a nitrogen valve to 0.09 Mpa, and the temperature was set to 150° C. After the continuously evaporated ethanol with water was dried by a drying tube, dried ethanol was continuously replenished to the dehydration reactor.

After heating for 4 hours, a sample was under nitrogen protection, and Karl Fischer was used to measure the moisture. After the moisture content was measured to be less than 0.02%, the ethanol dripping valve was closed, the valve of the receiving tank was opened, and the solvent was evaporated until a large amount of solid was precipitated. After cooling under nitrogen protection, the mixture was transferred to a nitrogen pressure filter device to separate the solid-liquid mixture to obtain solid. The solid was transferred to a negative pressure oven, heated at 140° C., for 3 h, to obtain 62 g of anhydrous lithium iodide solid.

The inventors compared the lithium iodide obtained in the above-described examples and summarized in the table as follows:

| Anhydrous | LiI % not | Impurities not more than (ppm) | | | | | | | | | | |
|---|---|---|---|---|---|---|---|---|---|---|---|---|
| lithium iodide | less than | Na | K | Ca | Mg | Fe | Pb | Ni | Zn | SO₄²⁻ | Cl⁻ | I |
| quality standard | 99.99 | 1 | 1 | 1 | 1 | 1 | 1 | 1 | 1 | 20 | 15 | 50 |
| Ex. 1 | 99.99 | 8 | 6 | 6 | 3 | <1 | <1 | 2 | 5 | <20 | <15 | <50 |
| Ex. 2 | 99.99 | 0.8 | 0.7 | 5 | 3 | <1 | <1 | 2 | 4 | <20 | <15 | <50 |
| Ex. 3 | 99.99 | 0.7 | 0.5 | 0.2 | 0.78 | <1 | <1 | 0 | 0.6 | <20 | <15 | <50 |
| Ex. 4 | 99.99 | 0.3 | 0.4 | 0.3 | 0.85 | <1 | <1 | 0 | 0.3 | <20 | <15 | <50 |

Note:
lithium iodide content is obtained by subtracting the total of impurities from 100%

Compared with Example 1, Example 2, Example 3, and Example 4 in the above table, it can be seen that the membrane filtration impurity removal step of the present invention can remove some impurities such as sodium and potassium. In Example 3, passes through the membrane and adjusting pH can further optimize the process and remove impurity ions such as calcium, magnesium, nickel, zinc. In Example 4, the optimization of the pore size of the membrane can obtain even better results.

The above are only preferred embodiments of the present invention and are not intended to limit the present invention. Any modification, equivalent replacement, and improvement made within the spirit and principle of the present invention shall be within the scope of the present invention.

1. A method of preparing an anhydrous lithium iodide, comprising: a lithium iodide trihydrate preparation step, a lithium iodide trihydrate dissolving step, a membrane filtration step, an azeotropic distillation step, a solvent recovery step, a solid-liquid separation step, and a solvent removal step,
wherein:
the lithium iodide trihydrate preparation step comprises reacting an industrial grade lithium hydroxide monohydrate with a hydroiodic acid under a condition of not exceeding 80° C., maintaining a negative pressure of 0.075-0.09 Mpa, and heating to 90° C.-110° C. to remove water, cooling and crystallizing to obtain a lithium iodide trihydrate;
the lithium iodide trihydrate dissolving step comprises dissolving the lithium iodide trihydrate in absolute ethanol in a 1:1-5 mass ratio under stirring to obtain a lithium iodide ethanol solution;
the membrane filtration step comprises adjusting a pH of the lithium iodide ethanol solution with a battery-grade lithium hydroxide, removing impurity through a membrane filtration device equipped with a membrane element under a pressure of 0.1-3.0 Mpa, and adjusting the pH of the lithium iodide ethanol solution again with a hydriodic acid;
the azeotropic distillation step comprises keeping the lithium iodide ethanol solution under the protection of a dry inert gas or reducing gas and a negative pressure of 0.08-0.09 Mpa, heating to 145-160° C. to continuously distill ethanol and water, passing the distilled ethanol and water through a drying tube to absorb the distilled water, returning the distilled ethanol to the lithium iodide ethanol solution, until a water content in the lithium iodide ethanol solution is reduced to 0.01-0.1%;
the solvent recovery step comprises evaporating the ethanol in the lithium iodide ethanol solution for precipitation to obtain a solid-liquid mixture, recovering the ethanol for reuse, closing a vacuum valve, and introducing a nitrogen protection;
the solid-liquid separation step comprises introducing the solid-liquid mixture into a nitrogen pressure filter device under the nitrogen protection to obtain a solid; and
the solvent removal step comprises transferring the solid to a negative pressure oven to maintain a negative pressure of 0.085-0.1 MPa, and drying at 135-150° C. to obtain the anhydrous lithium iodide.

2. The method according to claim 1, wherein in the lithium iodide dissolving step, the mass ratio of the lithium iodide trihydrate to the absolute ethanol in a 1:2.5.

3. The method according to claim 1, wherein in membrane filtration step, before membrane filtration, the pH of the lithium iodide ethanol solution is adjusted to 7-13 with the battery-grade lithium hydroxide; the pressure of the membrane filtration device is 0.1-3.0 Mpa; the membrane filtration device is a nanofiltration device; a pore size of the membrane element is 100 D-500 D; after membrane filtration, the pH is adjusted with a redistilled colorless hydriodic acid to 6.0-8.0.

4. The method according to claim 3, wherein, before membrane filtration,
the pH of the lithium iodide ethanol solution is adjusted to 10 with the battery-grade lithium hydroxide; the pressure of the membrane filtration device is 0.4-1.0 Mpa; the pore size of the membrane element is 150 D-250 D; after membrane filtration, the pH is adjusted with a redistilled colorless hydriodic acid to 7.0.

5. The method according to claim 1, wherein, in the azeotropic distillation step, the dry inert gas is argon or nitrogen, and the reducing gas is hydrogen; the lithium iodide ethanol solution is heated at 150° C.; the drying tube comprises calcium oxide or molecular sieve; and the water content in the lithium iodide ethanol solution is reduced to 0.02%.

6. The method according to claim 5, wherein the drying tube comprises molecular sieve.

7. The method according to claim 1, wherein, in the solvent removal step, the negative pressure is maintained at more than 0.09 MPa in the negative pressure oven and drying is at 140° C.
